(19) United States
(12) Patent Application Publication
(10) Pub. No.: US 2013/0187358 A1
(43) Pub. Date: Jul. 25, 2013

(54) BICYCLE FORK WITH BRAKE UNIT

(71) Applicants: Wolfgang Kohl, Schwabach (DE); Vincenz Thoma, KOBLENZ (DE); Lutz Scheffer, GARMISCH-PARTENKIRCHEN (DE)

(72) Inventors: Wolfgang Kohl, Schwabach (DE); Vincenz Thoma, KOBLENZ (DE); Lutz Scheffer, GARMISCH-PARTENKIRCHEN (DE)

(21) Appl. No.: 13/558,939

(22) Filed: Jul. 26, 2012

(30) Foreign Application Priority Data
Jul. 29, 2011 (EP) 11175984.1

(51) Int. Cl. B62K 21/02

(52) U.S. Cl. CPC B62K 21/02
USPC 280/279

(57) ABSTRACT

A bicycle fork with an integrated brake unit, in particular for racing bicycles and time-trial machines, comprises a fork crown connecting two fork legs with each other. A bottom bearing seat is connected with the fork crown. A brake unit is arranged below the fork crown, wherein an activation element, such as a Bowden cable or the like, for activating or actuating the brake unit is passed through the bottom bearing seat.

### CROSS REFERENCE TO RELATED APPLICATIONS

The present invention claims the priority of European Patent Application no. EP 11 175 984.1 filed on Jul. 29, 2011, the disclosures of which are incorporated herein by reference.

### BACKGROUND OF THE INVENTION

1. Field of the Invention

The invention refers to a bicycle fork with a brake unit in particular for racing bicycles, most preferably for use with time-trial machines.

2. Description of the Prior Art

With racing bicycles, and in particular with time-trial machines, aerodynamics is essential. Bicycle manufacturers are therefore interested in changing the position and design of the front wheel brake, since a front wheel brake arranged in front of the bicycle fork, seen in the direction of travel, causes substantial air turbulences and thereby strongly compromises aerodynamics. It is known to arrange the front wheel brake on the rear—seen in the direction of travel—of the fork crown or fork bridge connecting the two fork legs. Thereby, a certain enhancement of the aerodynamics can be achieved, since the front wheel brake is not directly flown against by the airflow. However, also in this case, substantial turbulences occur. Further, such brake arrangements have a drawback in that the brake cable is arranged laterally of the head tube of the frame and thereby also contributes to a deterioration of the aerodynamics.

Further, time-trial machines use so-called double bridge forks. Such a fork has a fork crown connecting the two fork legs, the fork crown carrying a lower bearing seat, such as a pivot bolt. The steer tube is arranged in front of the fork crown, seen in the travelling direction. Thus, the steer tube is arranged in front of the head tube of the bicycle frame. The upper steering bearing is supported by another component. This component is connected with the steer tube through the head tube of the frame and further represents the connection to the handlebar in the manner of a stem. Both steering bearings are connected through a solid, highly rigid threaded rod and are tightened against each other. This continuous head tube arranged between both steering bearings helps to realize the necessary rigidity.

### SUMMARY OF THE INVENTION

It is an object of the invention to provide a bicycle fork with a brake unit with which aerodynamics can be enhanced.

The object is achieved, according to the invention, with the features of claim 1.

The bicycle fork with a brake unit of the present invention, which has been developed in particular for racing bicycles and more preferably for time-trial machines, comprises two fork legs connected by a fork crown. The fork crown is connected with a bottom bearing seat, which is designed in particular as a pivot bolt. Here, the bearing seat preferably is of the type inserted from below into the head tube of a bicycle frame, while not passing completely through the head tube, so that no direct connection between the bottom bearing seat and the upper bearing seat has to be provided. In order to arrange a brake unit below or at least partly inside the fork crown, as provided by the invention, an activation element for the brake, such as a Bowden cable or the like, is passed through the bottom bearing seat or the bottom bearing element arranged in the bearing seat.

The activation element, which may be a hydraulic line or also an electric line instead of a cable, is thus lead to the brake unit substantially from above. This has the advantage that the actuation element is arranged inside the frame at least in this region and that it is not necessary to introduce a Bowden cable or another activation element from outside and laterally to the brake unit. Thereby, the aerodynamics of the bicycle can be enhanced further, since no activation element that could cause turbulences, such as a Bowden cable, is arranged in the airflow. Here, it is particularly preferred that the activation element is passed from the brake arm arranged on the handle bar preferably directly through the stem and then, according to a particularly preferred embodiment, through both the upper and the bottom bearing seat. Here, the two bearing seats may be connected with a head tube, in particular of rigid design, the head tube pre-tensioning in particular the two bearing elements arranged in the bearing seats.

A particularly preferred embodiment of the bicycle fork of the present invention additionally comprises a steer tube arranged offset with respect to the fork crown. The steer tube therefore preferably has no bearing and, in the assembled state, is arranged preferably in front of the head tube, seen in the direction of travel. The steer tube may be connected with an additional component, such as a stem, which then carries the upper bearing support and forms a connection to the handle bar.

According to the invention the brake unit is arranged below the fork crown. According to the invention, this is possible in a particularly preferred embodiment, since the steer tube is offset with respect to the fork crown and, in the assembled state, extends in front of the head tube, seen in the direction of travel. Since the steer tube extends downward in a substantially rectilinear manner and passes into the fork legs, a zone is created below the fork crown, in which the brake unit can be arranged. Because of the present arrangement of the brake unit below the fork crown of a double-bridge fork, an integration of the brake unit into the bicycle fork can be realized. Thereby, a significant improvement in aerodynamics can be achieved over bicycles in which the front wheel brake is arranged in front of or also behind the front wheel fork.

Although the arrangement of the activation element for the brake unit, as provided by the invention, is realized by means of the bottom bearing support, in particular also by means of the upper bearing support in combination, according to a preferred embodiment, with a double-bridge fork, such an arrangement of the activation element in connection with the brake unit situated below the fork crown, and possibly in the fork crown, is also possible with a conventional head tube connecting and in particular tensioning the two bearing elements.

The brake unit preferably comprises two brake arms arranged within the fork legs and/or the fork crown. Preferably, the brake arms are partly arranged in the upper portion of the fork legs directed toward the fork crown and partly within the fork crown. In a preferred embodiment, the brake arms do not protrude from the bicycle fork so that an aerodynamically optimized outer surface of the fork can be realized.

Preferably, the brake arms are pivotable brake arms whose pivot axis is also arranged in within the two fork legs and/or the fork crown. In a preferred embodiment, the two pivot levers are arranged in one plane so that the two brake jaws supported by the lower ends of the brake arms are arranged exactly opposite each other and, in particular, the forces transmitted onto the brake jaws are opposite each other in a plane arranged perpendicularly to the longitudinal direction or perpendicularly to the central plane of the front wheel. In a preferred embodiment also the two free brake arm ends, i.e. the ends of the brake arms that carry no brake jaws, are arranged opposite each other. In particular, the two brake arms do not cross each other.

Here, the pivot axes may be arranged above the ends carrying the brake jaws so that the brake is actuated by pressing apart the two upper free ends of the brake arms. It is also possible to arrange the pivot axes below the brake jaws, which would then be arranged in an intermediate part of the brake arms, so that the brake is actuated by pressing the two upper free ends of the brake arms together.

The two brake arms are preferably actuated by a common actuation means. The actuation means will be described hereunder with reference to a brake unit in which the pivot axes are arranged above the free ends carrying the brake jaws. A correspondingly designed actuation element may of course also be provided in a brake unit where the pivot axes are arranged below the brake jaws.

In a preferred embodiment the brake unit is therefore arranged between the two free brake arm ends. The actuation means preferably comprises at least one actuation element acting on the brake arm ends. For instance, it is possible that the two brake arm ends extend obliquely or are directed toward each other. A, for example, trapezoidal or triangular actuation element may be arranged between the two brake arm ends. By displacing or pulling such an actuation element upward, the two free ends of the brake arm ends are pressed apart. Since they are supported by the pivot axes, the two brake jaws are moved towards each other and are pressed against the rim.

In a particularly preferred embodiment of the actuation means the same comprises two actuation elements. The two actuation elements, which are preferably actuated through a common brake cable or a common hydraulic line, are preferably designed as pivot levers. The pivot levers which are in particular fixed to a holder element are pivoted, in particular together, by actuation of the brake cable or by application of hydraulic force. The pivot levers apply a force on the free ends of the brake arm ends, whereby the same are pressed apart. This, in turn, causes the two brake jaws to move towards each other.

The two actuation elements, preferably designed as pivot levers, are pivotably fixed on a holding element such that actuating the pivot levers will pivot them outward in opposite directions for braking. In particular, the holding element is arranged, in particular fixed, within the fork crown. In a preferred development, the holding element preferably comprises two lateral surfaces designed as abutment surfaces for the brake arm ends. In the open state of the brake the brake arms can abut against these surfaces.

For an enhancement of the aerodynamics, the invention provides that the activation element for the front wheel brake, like the brake cable or a corresponding hydraulic line, should preferably be arranged within the frame. In this case, it is preferred that the brake cable is passed through the fork crown and the bottom bearing seat. From there, the brake cable reaches the head tube of the frame from where it may be lead through the upper bearing seat and the component supporting the handle bar to the brake handle fastened on the handle bar. Further, it is preferred that the bearing seat, in particular designed as a bearing pivot, is closed at the top so that the top of the bearing seat can be used as a cable stop for the brake cable. Thus, the cable, including the sheath, can be passed through the head tube and the sheath terminates at the cable stop. Below the cable stop, the cable extends freely, i.e. without a sheath, to the actuation element the brake unit.

In a particularly preferred embodiment of the present bicycle fork with a brake unit, it is possible to design the same such that the cross section of the fork leg has a length-to-width ratio at the level of the tire of at most 3:1. In this respect, the present bicycle fork with brake unit also meets the strict rules of the UCI, i.e. the International Cycling Union.

### BRIEF DESCRIPTION OF THE DRAWINGS

A full and enabling disclosure of the present invention including the best mode thereof, enabling one of ordinary skill in the art to carry out the invention, is set forth in greater detail in the following description, including reference to the accompanying drawing in which

FIG. 1 is a schematic, partly sectional view of a bicycle frame in the region of the head tube together with the bicycle fork of the present invention,

FIG. 2 is a schematic side elevational view of the bicycle fork in the region of the fork crown, and

FIG. 3 is a schematic sectional rear view of the double bridge bicycle fork of the present invention.

### DESCRIPTION OF PREFERRED EMBODIMENTS

The present invention will be described hereunder with reference to a double bridge bicycle fork, while it is possible to provide the present arrangement of the brake unit below or partly within the fork crown in combination with a corresponding guiding of the actuation element, as provided by the invention, also in a conventional fork where the two bearing elements are connected by a rigid head tube.

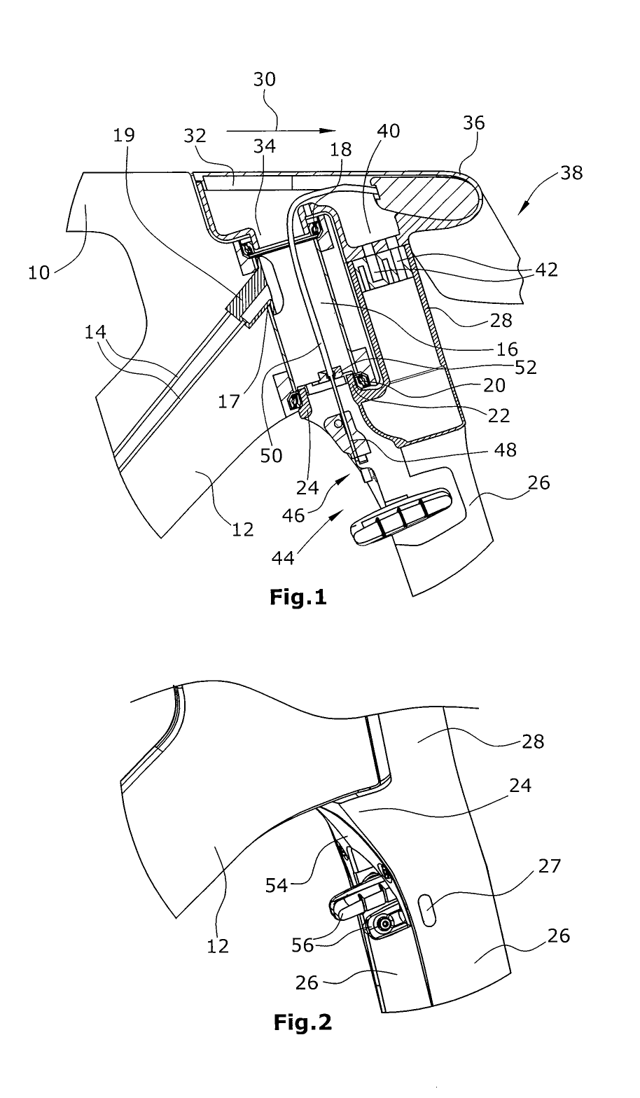

FIG. 1 schematically illustrates a detail of a time-trial machine. A top tube 10 is shown that is connected with a down tube 12, with switching cables 14 being arranged in the down tube 12. An upper bearing 18 and a lower bearing 20 are arranged in a head tube 16. The lower bearing 20 is supported by a bearing seat 22 formed as a bearing pivot. In the embodiment illustrated, the bearing seat 22 is formed as one piece with a fork crown 24. The fork crown 24 connects the two fork legs 26, the fork in particular being a fork made from a composite material, especially a fork reinforced with glass fibers, so that the fork crown 24 and the fork legs 26 are also formed integrally. Moreover, the fork comprises a steer tube 28 arranged in front of the head tube 16, seen in the direction of travel, and thus offset from the fork crown 24.

An upper component 32 comprises a bearing seat 34, also in the form of a pivot, for receiving the upper bearing 18, and thereby forming the stem. Further, the component 32 has a projection 36 that supports a bicycle handle bar 38, i.e. a triathlon handle bar in the embodiment illustrated. A projection 40, directed towards the steer tube 28, is provided between the bearing seat 34 and the projection 36. The projection 40 is connected to the steer tube 28 by means of screws 42.

Below the fork crown 24, a brake unit 44 is arranged that is integrated in the fork legs 26 and the fork crown 24. The brake unit 44 comprises an actuation means 46 to be operated through a Bowden cable 48. The Bowden cable 48 extends through the fork crown 24 and the bearing seat 22 into the inside of the head tube 16. The Bowden cable 48 further extends through the upper bearing 18 and from there to the handle bar 38 or the brake. The bearing seat 22 is closed at the top so that a sheath 50 of the Bowden cable 48 is arranged only within the head tube and extends up to the brake lever. The sheath 50 is retained in a cylindrical cable end stop 52 which is preferably formed integrally with the bearing seat 22.

According to the invention, the brake unit 44 is preferably arranged below a rotational axis of the fork, the rotational axis substantially coinciding with the sheath 50 within the head tube 16 in the embodiment illustrated.

In the assembled state (FIG. 2), the rear side of the fork legs 26, as well as of the fork crown 24, is closed with a cover element 54. As such, only the two brake jaws 56 are visible in the final assembled state of the brake unit 44.

For the adjustment of the brake jaws 56 an oblong hole 27 extending in the longitudinal direction can be provided on the outer side of the fork legs 26, respectively, through which the brake jaw can be adjusted using an Allen key, for instance.

Further, it is preferred that a recess is provided on an inner side of the fork legs 26 to receive at least a part of the brake jaws. Thereby, the distance of the fork legs can be reduced so that the outer dimensions of the fork are smaller than with conventional forks. This results in a further improvement of the aerodynamics.

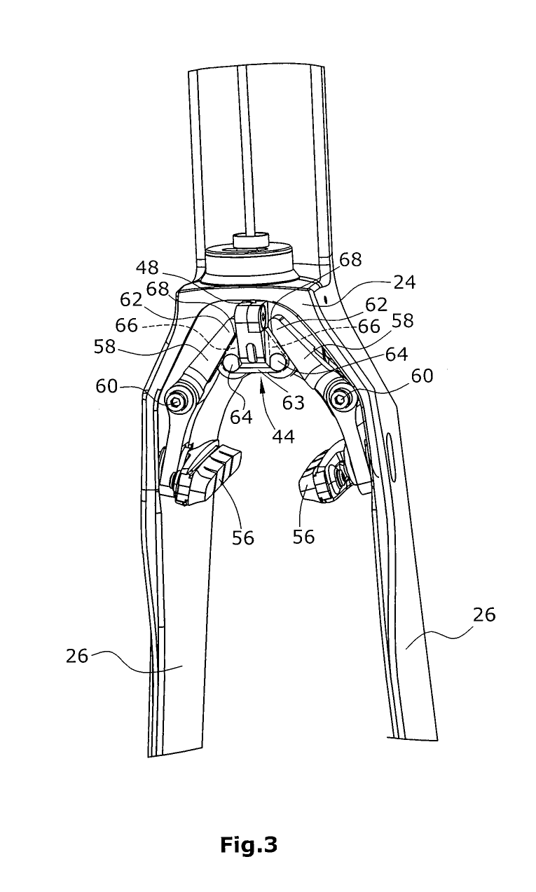

The double bridge bicycle fork of the present invention comprises two brake arms 58 (FIG. 3) arranged within the fork legs 26 and the fork crown 24. The two brake arms are supported for pivotal movement by pivot axes 60, the pivot axes 60 also being arranged within the fork legs 26 and the fork crown 24. When, for braking, the two free brake arm ends 62 are pressed apart out of the position illustrated in FIG. 3, in which no braking takes place, the two brake jaws 56 are moved inward towards the rim (not illustrated). The actuation means 44 is provided in order to realize this pivoting of the brake arms 58. Said means comprises a holding element 63 arranged within the fork crown. The holding element 63 carries two pivot axes 64 about which two pivot levers 66 may be pivoted, said levers being arranged within the holding element and being illustrated in dotted lines in FIG. 3. The pivot levers 66 are connected with the brake cable 48. By pulling the brake cable 48 upward in FIG. 3, the two pivot levers 66 are pivoted outward. Thereby, the free ends 62 of the brake arms 58 are pressed outward which, in turn, causes a movement of the two brake jaws inward towards the rims.

The holding element 63 of substantially trapezoidal shape, seen in top plan view, comprises two obliquely arranged lateral surfaces 68 against which the free ends of the brake arms 58 abut when the brake is not actuated.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

what is claimed is:

1. A bicycle fork with a brake unit, in particular for racing bicycles, comprising
a fork crown connecting two fork legs with each other,
a bottom bearing seat connected with the fork crown, and
a brake unit arranged below the fork crown,
wherein an activation element for the brake unit is passed through the bottom bearing seat.

2. The bicycle fork of claim 1, further comprising an upper bearing seat through which the activation element is also passed.

3. The bicycle fork of claim 1, wherein the brake unit comprises two brake arms arranged within the fork legs and/or the fork crown.

4. The bicycle fork of claim 3, wherein the brake arms are supported by pivot axes arranged within the fork legs and/or the fork crown.

5. The bicycle fork of claim 3, further comprising two free brake arm ends are arranged opposite each other.

6. The bicycle fork of claim 3, wherein the two brake arms are actuable by means of a common actuation means.

7. The bicycle fork of claim 6, wherein the actuation means comprises at least one actuation element acting on the brake arm end, wherein, preferably, two actuation elements are preferred that respectively act on one brake arm end.

8. The bicycle fork of claim 7, wherein the two actuation elements are adapted to be operated together.

9. The bicycle fork of claim 7, wherein the two actuation elements are designed as pivot levers arranged in a holding element fixed within the fork crown.

10. The bicycle fork of claim 6, wherein the activation element is connected with the actuation means, in particular with the at least one actuation element of the actuation means.

11. The bicycle fork of claim 9, wherein the holding element preferably comprises two lateral surfaces formed as abutment surfaces for the brake arm ends.

12. The bicycle fork of claim 3, wherein the fork legs have a length-to-width ratio of at most 3:1 in the region of the lower ends of the brake arms.

13. The bicycle fork of claim 1, further comprising a steer tube offset with respect to the fork crown.
